(19) United States
(12) Patent Application Publication
(10) Pub. No.: US 2023/0153875 A1
(43) Pub. Date: May 18, 2023

(54) PAYMENT METHOD AND SYSTEM

(71) Applicant: Kavin Khadgi, Jackson Heights, NY (US)

(72) Inventor: Kavin Khadgi, Jackson Heights, NY (US)

(21) Appl. No.: 18/053,065

(22) Filed: Nov. 7, 2022

Related U.S. Application Data
(60) Provisional application No. 63/280,277, filed on Nov. 17, 2021.

(51) Int. Cl. G06Q 30/04; G06Q 20/10; G06Q 20/38; G06Q 20/42; G06Q 30/0251

(52) U.S. Cl. CPC G06Q 30/04; G06Q 20/102; G06Q 20/389; G06Q 20/42; G06Q 30/0269

(57) ABSTRACT

A method for facilitating business-to-business payments. Invoice data and customer data from are received from a vendor; defined mapping data is received from a vendor; standardized invoice data is generated from the transformation of the invoice data based on the defined mapping data; standardized customer data is generated from the transformation of the customer data based on the defined mapping data; the standardized invoice data is transmitted to a customer and at least one of an invoice payment and an invoice payment confirmation are received from the customer. A payment system may comprise memory storing executable instructions and a processing device executing the instructions, the instructions causing the processing device to perform the method.

### CROSS-REFERENCE TO RELATED APPLICATIONS

This application claims the benefit of U.S. provisional patent application No. 63/280,277 filed on Nov. 17, 2021, the content of which is incorporated by reference in its entirety.

### BACKGROUND

### Field of the Invention

The present invention relates generally to business data processing, and, in particular, to methods and systems for facilitating customer to vendor payments.

### Scope of the Prior Art

For small and medium scale businesses (herein customers), handling vendor invoices is often a complex task. A lot of the work is performed manually as most vendors still use post mail services to send invoices in the form of a printed copy. In return, customers fulfil the invoices by mailing checks back to the vendor.

Some vendors do have their own web service in which customers can log in to view invoices and statements. However, for customers who have accounts with many vendors, it quickly becomes impossible to keep track of invoices and payments. Often customers end up incurring additional late payment fees. As evidenced, the entire process of handling invoices is rather tedious. Therefore, there is a need for improved methods and systems for facilitating the transfer of vendor invoices and customer payments, all through a centralized application.

### SUMMARY

One aspect of the present disclosure is directed at a method for facilitating business-to-business payments. The method may comprise: Invoice data and customer data from are received from a vendor; defined mapping data is received from a vendor; standardized invoice data is generated from the transformation of the invoice data based on the defined mapping data; standardized customer data is generated from the transformation of the customer data based on the defined mapping data; the standardized invoice data is transmitted to a customer; and at least one of an invoice payment and an invoice payment confirmation are received by the customer.

The method may further comprise: A payment receipt notification is transmitted to one the vendor and the customer; and the transactional data of a transaction is stored, the transactional data comprising at least one of: the invoice data and the customer data, the standardized invoice data and the standardized customer data, the invoice payment, the invoice payment confirmation, and the payment receipt notification.

The method may further comprise: The transactional data associated with a transaction is retrieved; and the transactional data is transported.

The method may further comprise: The vendor is matched to the customer based on the customer data shared with a customer profile of the customer.

The method may further comprise: A payment request is generated based on the standardized invoice data and the standardized customer data; and the payment request is transmitted to the customer.

The method may further comprise: Conversational content associated with a transaction is received; and the conversational content is transmitted to one of the vendor and the customer. The conversational content may comprise at least one of textual content, audio content, an image, and audio-video content.

The method may further comprise: Marketing content is received from the vendor; The marketing content may comprise a product catalog and target audience data, wherein the product catalog comprises product details associated with a plurality of products sold by the vendor and wherein the target audience comprises audience data associated with a potential new customer; the potential new customer is identified based on the audience data; and the product catalog is transmitted to the potential new customer.

The method may further comprise: A product request is received from a customer; a potential new supplier is identified; and the product request is transmitted to the potential new supplier.

The method may further comprise: At least one of the standardized invoice data and the standardized customer data is transmitted to the vendor or the customer; a correctness alert is received from the vendor or the customer; and wherein the transmitting of the standardized invoice data to the customer is based on the correctness alert.

The method may further comprise: An request for an invoice copy is received from one of the vendor and the customer; a digital copy of the standardized invoice data is retrieved; and the digital copy is transmitted.

The method may further comprise: A request to resolve a dispute is received from one of the vendor and the customer.

Another aspect of the present disclosure is directed at a payment system for facilitating business-to-business payments. The system may comprise: memory storing executable instructions; and a processing device executing the instructions, wherein the instructions cause the processing device to perform individually, or in combination, the aforementioned method steps.

Another aspect of the present disclosure is directed at non-transitory computer storage media storing executable instructions which when executed by a computing device cause the computing device to perform individually, or in combination, the aforementioned method steps.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 shows a block diagram illustrating example physical components of a payment system with which aspects of the disclosure may be practiced.

FIG. 2 is a flowchart showing steps of vendor-customer matching method, according to an embodiment.

FIG. 3 is a flowchart showing steps of vendor-customer transaction method, according to an embodiment.

FIG. 4 is a flowchart showing steps of payment receipt notification method, according to an embodiment.

FIG. 5 is a flowchart showing steps of transaction data transmission method, according to an embodiment.

FIG. 6 is a flowchart showing steps of conversational content transmission method, according to an embodiment.

FIG. 7 is a flowchart showing steps of vendor-customer marketing method, according to an embodiment.

FIG. 8 is a flowchart showing steps of an invoice data retrieval method, according to an embodiment.

### DETAILED DESCRIPTION

The disclosed approaches may be provided in a variety of manners, for example, procedural, computer implemented, integrated into a system or apparatus, provided as a computer programming product, and the like.

In the present specification, an implementation showing a singular component should not be considered limiting; rather, the disclosure is intended to encompass other implementations including a plurality of the same component, and vice-versa, unless explicitly stated otherwise herein. Further, the present disclosure encompasses present and future known equivalents to the components referred to herein by way of illustration.

It will be recognized that while certain aspects of the technology are described in terms of a specific sequence of steps of a method, these descriptions are only illustrative of the broader methods of the disclosure and may be modified as required by the particular application. Certain steps may be rendered unnecessary or optional under certain circumstances. Additionally, certain steps or functionality may be added to the disclosed implementations, or the order of performance of two or more steps permuted. All such variations are considered to be encompassed within the disclosure disclosed and claimed herein.

For the sake of convenience, the terms used to describe the prior art and various embodiments of the present invention are defined below.

Vendor: A first entity that provides a good or service in exchange for a payment.

Customer: A second entity that provides a payment in exchange for a good or service.

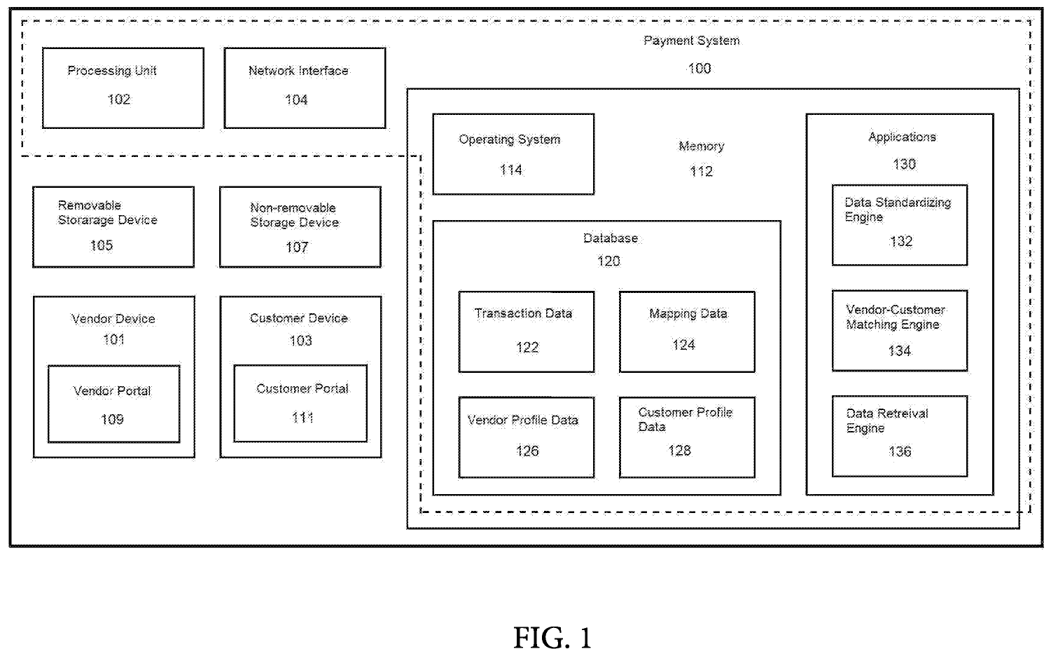

FIG. 1 is a block diagram illustrating example physical components (e.g. hardware) of a payment system 100. The basic configuration is illustrated by those components within the dashed line. In this basic configuration, the payment system 100 may include at least one processing unit 102, a network interface 104, and memory 112.

The processing unit 102 executes commands to perform the functions specified in flowcharts and/or block diagram blocks throughout this disclosure. It should be appreciated that processing may be implemented either locally via the processing unit 102 or remotely via various forms of wireless or wired networking technologies or a combination of both.

The term computer readable media as used herein may include computer storage media. Computer storage media may include volatile and nonvolatile, removable and non-removable media implemented in any method or technology for storage of information, such as computer readable instructions, data structures, or program modules. The memory 112, the removable storage device 105, and the non-removable storage device 107 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the payment system 100. In some embodiments, such computer storage media may be part of the payment system 100. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Memory 112 may include various types of short and long-term memory as is known in the art. Memory 112 may be loaded with various applications 130 in the form of as computer readable program instructions. These computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Applications 130 may include a data standardization engine 132, a vendor-customer matching engine 134, and a data retrieval engine 136. Accordingly, memory 112 includes all necessary applications per each embodiment.

The data standardization engine 132 is configured to generate standardized data based on vendor provided defined mapping data as will be further discussed. According to an embodiment, the data standardization engine 132 transforms invoice data into standardized invoice data and customer data into standardized customer data.

The vendor-customer matching engine 134 matches vendors to customers as will be further discussed. According to an embodiment, the vendor-customer matching engine 134 compares vendor provided customer data to customer provided customer profile data, as well as customer provided vendor data to vendor provided vendor profile data, to connect known business collaborators.

The data retrieval engine 136 retrieves data from the database 120 upon request.

Memory 112 may also include an operating system 114 and a database 120 loaded with transaction data 122, mapping data 124, vendor profile data 126, and customer profile data 128, as will be further discussed. In certain embodiments, the database 120 may be implemented locally, whereas in other embodiments, the database 120 may be implemented remotely.

The operating system 114 is suitable for controlling the operation of the payment system 100.

Transaction data 122 may comprise vendor provided invoice data, standardized invoice data, vendor provided customer data, standardized customer data, customer provided vendor data, invoice payment data, invoice payment confirmation data, payment receipt data, and the like.

Invoice data may comprise any data related to the invoice such as customer name, number, invoice number, invoice date, invoice amount, invoice type (debit-invoice or credit-credit memo), and invoice due date. The payment system receives invoice data in the format used by the vendor system.

Customer data may comprise any data related to the customer such as customer name, address, tax ID, and phone number. The payment system receives customer data in the format used by the vendor system.

Vendor data may comprise any data related to the vendor such aa vendor name, address, tax ID, and phone number. The payment system receives vendor data in the format used by the customer system.

Invoice payment data may comprise any data related to a payment sent through the payment system such as the payment amount and payment time.

Invoice payment confirmation data may comprise any data related to a payment sent outside of the payment system such as payment method, payment amount, and payment time.

Mapping data 124 may comprise the transformative logic required to transform the data used by the vendor system into the data used by the payment system. The payment system receives vendor defined mapping data from each vendor.

Vendor profile data 126 may comprise any data associated with the vendor such as vendor name, address, tax ID, and phone number. The payment system receives vendor specific profile data from each vendor.

Customer profile data 126 may comprise any data associated with the customer such as customer name, address, tax ID, and phone number. The payment system receives customer specific profile data from each customer.

The payment system 100 may further comprise a vendor device 101 and a customer device 103. The vendor device 101 may be any device that permits a vendor to access the payment system such as a computer or smartphone. Vendor devices may be configured to support a vendor portal 109 that permits easy access to the payment system. The customer device 103 may be any device that permits a customer to access the payment system such as a computer or smartphone. Customer devices may be configured to support a customer portal 111 that permits easy access to the payment system.

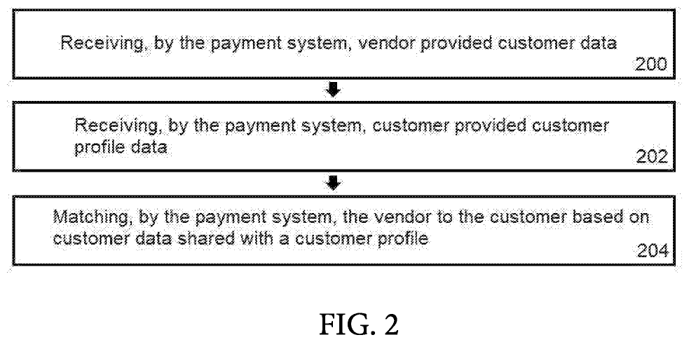

FIG. 2 is a flowchart showing steps of vendor-customer matching method, according to an embodiment. The method may begin at step 200.

At step 200, the payment system receives customer data from a vendor. For example, the vendor provides part of or all of their customer data of [Customer name: “Frank's Burgers”, Customer location: “California”].

At step 202, the payment system receives customer profile data from a customer. This may occur when a customer signs into the payment system using a payment system associated portal such as a mobile application, website, and the like. For example, the customer provides customer profile data of [Customer name: “Frank's Burgers”, Customer phone number: “(123) 456-7890”, Customer business: “restaurant”] into a web site associated with the payment system.

At step 204, the payment system matches the vendor to the customer based on shared data between the vendor and the customer. For example, the payment system recognizes that the vendor is searching for a customer named “Frank's Burgers” and that a customer profile contains a customer name of “Frank's Burgers.” Thus, the payment system matches the vendor to Frank's Burgers. Vendor-customer matching may be facilitated using a key algorithm on multiple profile criteria to perform accurate match between a vendor and customer.

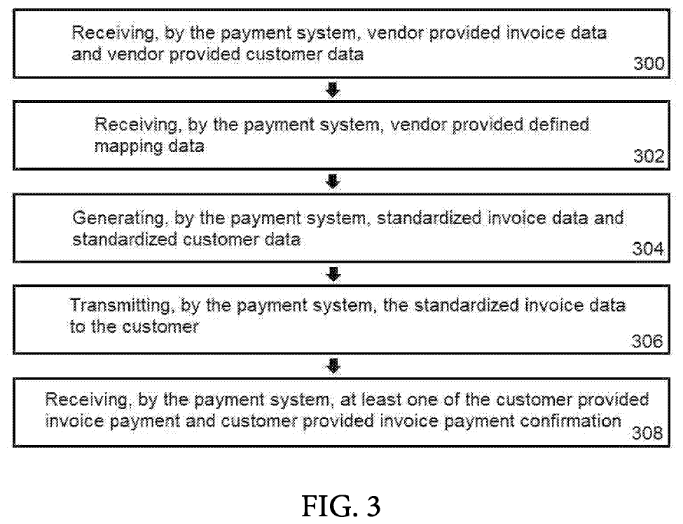

FIG. 3 is a flowchart showing steps of vendor-customer transaction method, according to an embodiment. The method may begin at step 300.

At step 300, the payment system receives invoice data and customer data from a vendor. For example, the vendor provides invoice data of [Customer name: “Frank's Burgers”, Invoice number: “1001”, Invoice date: “Oct. 30, 2022”, Amount due: “$100”, Invoice due date: “Nov. 30, 2022”, Delivery notes: “For Friday's Shipment”] and customer data of [Customer name: “Frank's Burgers”, Customer location: “California”].

At step 302, the payment system receives defined mapping data from the vendor. The mapping data helps identify key data fields in the vendor system and then transforms those key data fields into a standardized format used by the payment system and distributed to customers.

At step 304, the payment system generates, based on the defined mapping data, standardized invoice data and standardized customer data. For example, the payment system generates standardized invoice data of [Invoice number: “1001”, Invoice date: “Oct. 30, 2022”, Amount due: “$100”, Invoice due date: “Nov. 30, 2022”] and standardized customer data of [Customer name: “Frank's Burgers”].

At step 306, the payment system transmits the standardized invoice data to a customer. For example, the payment system transmits the standardized invoice data of [Invoice number: “1001”, Invoice date: “Oct. 30, 2022”, Amount due: “$100”, Invoice due date: “Nov. 30, 2022”] to Frank's Burgers.

At step 308, the payment system receives an invoice payment or an invoice payment confirmation from a customer. For example, Frank's Burgers pays an outstanding invoice, generating an invoice payment confirmation in the form of an ACH transfer, wire transfer, or credit card receipt confirming the payment.

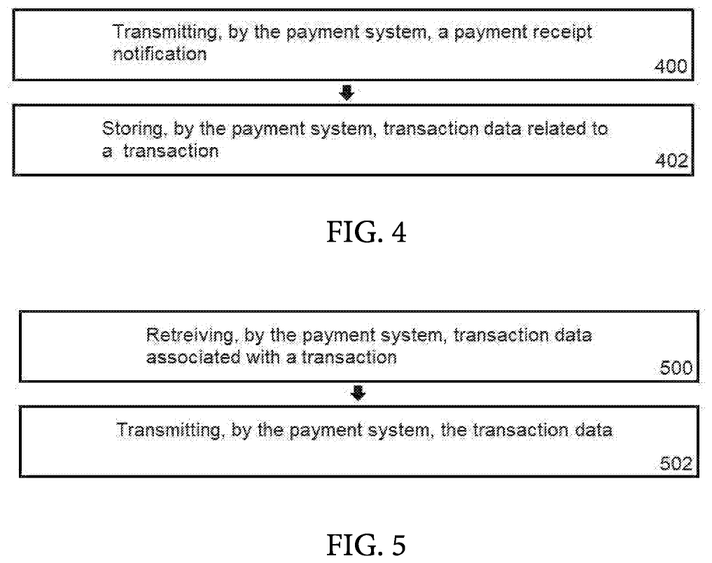

FIG. 4 is a flowchart showing steps of payment receipt notification method, according to an embodiment. The method may begin at step 400.

At step 400, the payment system transmits a payment receipt notification to the vendor or the customer. For example, Frank's Burger receives a text, email, or mobile app notification that the vendor payment was successful.

At step 402, the payment system stores transaction data associated with a transaction. For example, the payment system stores the invoice data of [Customer name: “Frank's Burgers”, Invoice number: “1001”, Invoice date: “Oct. 30, 2022”, Amount due: “$100”, Invoice due date: “Nov. 30, 2022”, Delivery notes: “For Friday's Shipment”], customer data of [Customer name: “Frank's Burgers”, Customer location: “California”, Customer business: “Restaurant”], standardized invoice data of [Invoice number: “1001”, Invoice date: “Oct. 30, 2022”, Amount due: “$100”, Invoice due date: “Nov. 30, 2022”], standardized customer data of [Customer name: “Frank's Burgers”], a .pdf file of the invoice, and a .txt file of the payment receipt notification.

FIG. 5 is a flowchart showing steps of transaction data transmission method, according to an embodiment. The method may begin at step 500.

At step 500, the payment system retrieves some or all of the transaction data associated with a transaction. For example, the payment system retrieves transaction data of [Customer name: “Frank's Burgers”, Customer location: “California”].

At step 502, the payment system transmits some or all of the transaction data to a vendor or a customer. For example, the payment system transmits transaction data of [Customer name: “Frank's Burgers”, Customer location: “California”] to Frank's Burgers, as well as all other transaction data related to the transaction.

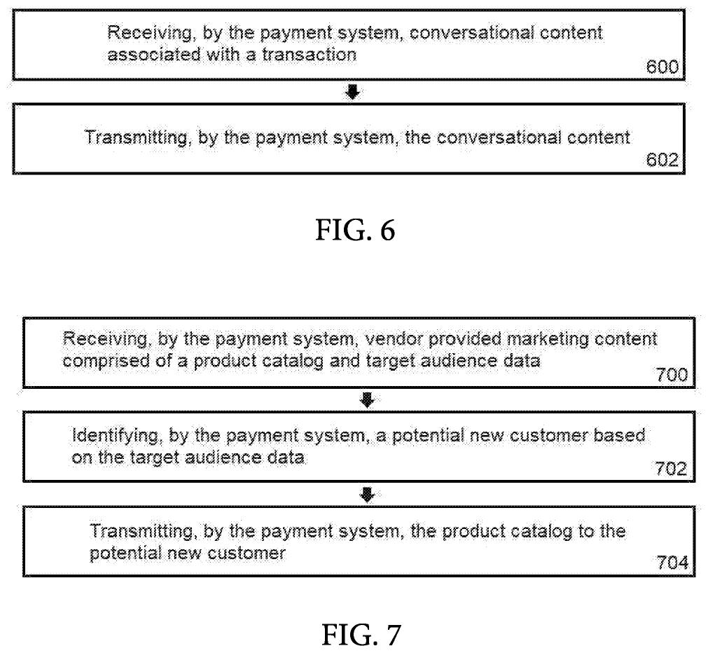

FIG. 6 is a flowchart showing steps of conversational content transmission method, according to an embodiment. The method may begin at step 600.

At step 600, the payment system retrieves conversational content associated with a transaction. For example, the payment system retrieves a vendor message of “Thanks for the payment”. Conversational content may comprise, but is not limited to, textual content, audio content, an image, and audio-video content. Conversational content may be sent to any user of the payment system such as vendors, customers, and sales representatives.

At step 602, the payment system transmits the conversational content to a vendor or a customer. For example, the payment system transmits “Thanks for the payment” to Frank's Burgers.

FIG. 7 is a flowchart showing steps of vendor-customer marketing method, according to an embodiment. The method may begin at step 700.

At step 700, the payment system receives a product catalog and target audience data from a vendor. For example, a vendor provides a product catalog of [Item 1: “Chicken”, Price 1: “$1.99/lb”, Item 2: “Beef”, Price 2: “$4.99/lb”] and target audience data of [restaurant, grocery store]. Alternatively, the payment system receives a product request from a customer. For example, a customer provides a product request of [Item 1: “Chicken”].

At step 702, the payment system identifies, based on the target audience data, a potential new customer for the vendor. For example, Ray's Grocery is identified as a potential new customer as Ray's Grocery's customer profile lists the Customer business as “grocery store”. Alternatively, the payment system identifies, based on the product request, a potential new supplier for the customer. For example, Bob's Wholesale Chicken is identified as a potential new supplier as Bob's Wholesale Chicken vendor profile lists chicken in its product catalog.

At step 704, the payment system transmits the product catalog to the potential new customer. For example, Ray's Grocery receives the vendor's product catalog of [Item 1: “Chicken”, Price 1: “$1.99/lb”, Item 2: “Beef”, Price 2: “$4.99/lb”]. Alternatively, the payment system transmits the product request to the potential new supplier. For example, Bob's Wholesale Chicken receives the customer's product request of chicken.

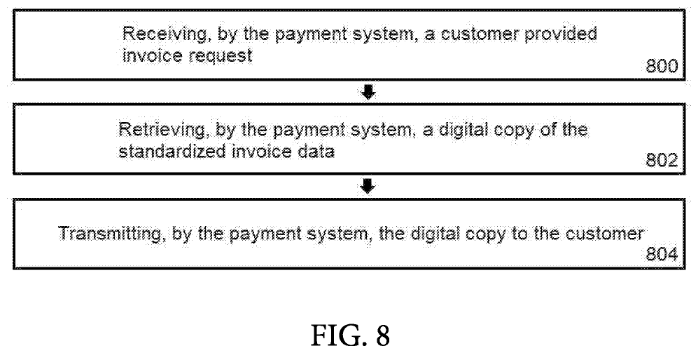

FIG. 8 is a flowchart showing steps of an invoice copy retrieval method, according to an embodiment. The method may begin at step 800.

At step 800, the payment system receives an request for an invoice copy from a vendor or a customer. For example, a Frank's Burgers provides an invoice request.

At step 802, the payment system retrieves a digital copy of the standardized invoice data. For example, the payment system retrieves a digital copy of the standardized invoice data of [Invoice number: “1001”, Invoice date: “Oct. 30, 2022”, Amount due: “$100”, Invoice due date: “Nov. 30, 2022”].

At step 804, the payment system transmits the digital copy of the standardized invoice data to the customer. For example, Frank's Burgers receives a .pdf file containing the standardized invoice data in invoice/bill image format.

Accordingly, the method may further include receiving, by the payment system, a request to resolve a dispute. The dispute appeal may be associated with a dispute raised by the at least one vendor or customer. Further, the dispute may notify the at least one party to the transaction about the invoice that may have incorrect invoice amounts. Further, the method may include transmitting, by the payment system, the dispute appeal to at least one party to the transaction. Further, the method may include receiving, by the payment system, a revised invoice from the at least one party to the transaction. The revised invoice may include a revised amount that may resolve the dispute raised by the at least one party to the transaction. Further, the method may include transmitting, by the payment system, the revised invoice to the at least one party to the transaction. Alternatively, the receiving of the payment may be based on the revised invoice. Further, the method may include storing, using the storage device, the revised invoice.

Methods in this document are illustrated as blocks in a logical flow graph, which represent sequences of operations that can be implemented in hardware, software, or a combination thereof. In the context of software, the blocks represent computer-executable instructions stored on one or more computer storage media that, when executed by one or more processors, cause the processors to perform the recited operations. Note that the order in which the processes are described is not intended to be construed as a limitation, and any number of the described method blocks can be combined in any order to implement the illustrated method, or alternate methods. Additionally, individual blocks may be deleted from the methods without departing from the spirit and scope of the subject matter described herein.

I claim:

1. A method for facilitating business-to-business payments, the method comprising:
receiving, by a payment system, invoice data and customer data from a vendor;
receiving, by the payment system, defined mapping data from the vendor;
generating, by the payment system, standardized invoice data from the transformation of the invoice data based on the defined mapping data;
generating, by the payment system, standardized customer data from the transformation of the customer data based on the defined mapping data;
transmitting, by the payment system, the standardized invoice data to a customer; and
receiving, by the payment system, at least one of an invoice payment and an invoice payment confirmation from the customer.

2. The method of claim 1, further comprising:
transmitting, by the payment system, a payment receipt notification to the vendor or the customer; and
storing, by the payment system, transactional data of a transaction, the transactional data comprising at least one of:
the invoice data and the customer data,
the standardized invoice data and the standardized customer data,
the invoice payment,
the invoice payment confirmation,
and the payment receipt notification.

3. The method of claim 2, further comprising:
retrieving, by the payment system, the transactional data associated with a transaction;
transmitting, by the payment system, the transactional data.

4. The method of claim 1, further comprising:
matching, by the payment system, the vendor to the customer based on the customer data shared with a customer profile of the customer.

5. The method of claim 1, further comprising:
generating, by the payment system, a payment request based on the standardized invoice data and the standardized customer data; and
transmitting, by the payment system, the payment request to the customer.

6. The method of claim 1, further comprising:
receiving, by the payment system, conversational content associated with a transaction; and
transmitting, by the payment system, the conversational content to one of the vendor and the customer.

7. The method of claim 6, wherein the conversational content comprises at least one of textual content, audio content, an image, and audio-video content.

8. The method of claim 1, further comprising:
receiving, by the payment system, marketing content from the vendor;
wherein the marketing content comprises a product catalog and target audience data;
wherein the product catalog comprises product details associated with a plurality of products sold by the vendor;
wherein the target audience comprises audience data associated with a potential new customer;
identifying, by the payment system, the potential new customer based on the target audience data;
transmitting, by the payment system, the product catalog to the potential new customer.

9. The method of claim 1, further comprising:
receiving, by the payment system, a product request from a customer;
identifying, by the payment system, a potential new supplier; and
transmitting, by the payment system, the product request to the potential new supplier.

10. The method of claim 1, further comprising:
transmitting to the vendor or the customer, by the payment system, at least one of:
the invoice data and the customer data;
the standardized invoice data and the standardized customer data;
receiving, by the payment system, a correctness alert from the vendor or the customer;
wherein the transmitting of the standardized invoice data to the customer is based on the correctness alert.

11. The method of claim 1, further comprising:
receiving, by the payment system, a request for an invoice copy;
retrieving, by the payment system, a digital copy of the standardized invoice data; and
transmitting, by the payment system, the digital copy of the standardized invoice data.

12. The method of claim 1, further comprising:
receiving, by the payment system, a request to resolve a dispute by one of the vendor and the customer.

13. A payment system for facilitating business-to-business payments, the system comprising:
memory storing executable instructions;
a processing device executing the instructions, wherein the instructions cause the processing device to:
receive, by a payment system, invoice data and customer data from a vendor;
receive, by the payment system, defined mapping data from the vendor;
generate, by the payment system, standardized invoice data from the transformation of the invoice data based on the defined mapping data;
generate, by the payment system, standardized customer data from the transformation of the customer data based on the defined mapping data;
transmit, by the payment system, the standardized invoice data to a customer; and
receive, by the payment system, one of an invoice payment and an invoice payment confirmation from the customer.

14. The payment system of claim 13, wherein the instructions further cause the processing device to:
transmit, by the payment system, a payment receipt notification to one of the vendor and the customer; and
store, by the payment system, transactional data comprising at least one of:
the invoice data and the customer data,
the standardized invoice data and the standardized customer data,
the invoice payment,
the invoice payment confirmation,
and the payment receipt notification.

15. The payment system of claim 13, wherein the instructions further cause the processing device to:
match, by the payment system, the vendor to the customer based on the customer data shared with a customer profile of the customer.

16. The payment system of claim 13, wherein the instructions further cause the processing device to:
receive, by the payment system, conversational content associated with the invoice data and customer data, from one of the vendor and the customer;
wherein the conversational content comprises at least one of textual content, audio content, an image, and audio-video content; and
transmit, by the payment system, the conversational content.

17. The payment system of claim 14, wherein the instructions further cause the processing device to:
receive, by the payment system, marketing content from the vendor;
wherein the marketing content comprises a product catalog and target audience data;
wherein the product catalog comprises product details associated with a plurality of products sold by the vendor;
wherein the target audience comprises audience data associated with a potential new customer;
identify, by the payment system, the potential new customer based on the audience data; and
transmit, by the payment system, the product catalog to the potential new customer.

18. Non-transitory computer storage media storing executable instructions which when executed by a computing device cause the computing device to:
receive, by a payment system, invoice data and customer data from a vendor;
receive, by the payment system, defined mapping data from the vendor;
generate, by the payment system, standardized invoice data from the transformation of the invoice data based on the defined mapping data;
generate, by the payment system, standardized customer data from the transformation of the customer data based on the defined mapping data;
transmit, by the payment system, the standardized invoice data to a customer; and
receive, by the payment system, one of an invoice payment and an invoice payment confirmation from the customer.

19. The non-transitory computer storage media of claim 18, wherein the instructions further cause the computing device to:
transmit, by the payment system, a payment receipt notification to one of the vendor and the customer; and
store, by the payment system, transactional data comprising at least one of:
the invoice data and the customer data,
the standardized invoice data and the standardized customer data,
the invoice payment,
the invoice payment confirmation,
and the payment receipt notification.

20. The non-transitory computer storage media of claim 18, wherein the instructions further cause the computing device to:
receive, by the payment system, marketing content from the vendor;
wherein the marketing content comprises a product catalog and target audience data;
wherein the product catalog comprises product details associated with a plurality of products sold by the vendor;
wherein the target audience comprises audience data associated with a potential new customer;
identify, by the payment system, the potential new customer based on the audience data; and
transmit, by the payment system, the product catalog to the potential new customer.
